(19) United States
(12) Patent Application Publication
(10) Pub. No.: US 2007/0277846 A1
(43) Pub. Date: Dec. 6, 2007

(54) Dental floss tooth pick

(76) Inventor: Chien Shun Chao, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/444,207

(22) Filed: May 31, 2006

(51) Int. Cl. A61C 15/00

(52) U.S. Cl. 132/326

(57) ABSTRACT

A dental floss tooth pick includes a holder having a space formed between two arms, a dental floss filament attached onto the holder and engaged with the free end portions of the arms and extended through the space of the holder, and a tightening device having a rotatable mandrel for engaging with the dental floss filament and for rotating the dental floss filament relative to the holder to rotate and tighten the dental floss filament to the holder. The mandrel includes an orifice formed in an upper portion, or an aperture formed in a lower portion for receiving and for rotating the dental floss filament and for rotating the dental floss filament relative to the holder.

### BACKGROUND OF THE INVENTION

1. Field of the Invention

The present invention relates to a dental floss tooth pick, and more particularly to a dental floss tooth pick including a dental floss attachable onto a U-shaped holder and tightenable onto the U-shaped holder by the users themselves.

2. Description of the Prior Art

Typical dental floss members are wound and stored in a bobbin or coil and received within a casing or receptacle, for allowing the dental floss to be pulled out of the receptacle by the users, and for cleaning the teeth of the users.

For allowing the dental floss to be easily and readily used by the users, the dental floss has been secured or molded into a number of U-shaped handles in order to form a disposable dental floss tooth pick.

For example, U.S. Pat. No. 3,769,396 to Espinosa discloses one of the typical methods for preparing measured lengths of dental floss also comprising or preparing an elongated dental floss filament for being secured or molded into a number of U-shaped handles.

The dental floss filament is required to be cut into a number of segments and secured or molded into two separated arms of each of the U-shaped handles. However, the ends of the cut segments are simply molded and retained in the separated arms of the U-shaped handles and may not be suitably tightened onto the handles, or no twisting or tightening means or device may be provided for twisting or tightening the dental floss filament onto the separated arms of the U-shaped handles.

U.S. Pat. No. 3,926,201 to Katz discloses a typical method for making a disposable dental floss tooth pick also comprising an elongated dental floss filament required to be cut into a number of segments and secured or molded into two separated arms of each of a number of U-shaped handles.

However, similarly, the ends of the cut segments are simply molded and retained in the separated arms of the U-shaped handles and may not be suitably tightened onto the handles, or no twisting or tightening means or device may be provided for twisting or tightening the cut segments of the dental floss filament onto the separated arms of the U-shaped handles.

The present invention has arisen to mitigate and/or obviate the afore-described disadvantages of the conventional dental floss tooth picks.

### SUMMARY OF THE INVENTION

The primary objective of the present invention is to provide a dental floss tooth pick including a dental floss attachable onto a U-shaped holder and tightenable onto the U-shaped holder by the users themselves.

In accordance with one aspect of the invention, there is provided a dental floss tooth pick comprising a holder including a first arm and a second arm extended therefrom for forming a space between the first and the second arms, the first and the second arms each including a free end portion, a dental floss filament attached onto the holder and engaged with the free end portions of the first and the second arms and extended through the space of the holder, and a tightening device for tightening the dental floss filament to the holder.

The tightening device includes a rotatable mandrel for engaging with the dental floss filament and for rotating the dental floss filament relative to the holder to rotate and tighten the dental floss filament to the holder. The mandrel includes an orifice formed in an upper portion thereof for receiving the dental floss filament and for rotating the dental floss filament relative to the holder.

The mandrel includes an aperture formed in a lower portion thereof for receiving the dental floss filament and for rotating the dental floss filament relative to the holder. The first arm includes a bore formed therein for rotatably receiving the mandrel and includes a slot formed in the free end portion of the first arm for aligning with the aperture of the mandrel and for receiving the dental floss filament.

The mandrel includes a lock notch formed therein and communicating with the aperture of the mandrel for receiving and engaging with the dental floss filament. The mandrel includes a handle provided thereon for rotating the mandrel relative to the holder.

The holder includes a notch formed therein for selectively receiving the handle. The holder includes an anchoring member extended into the notch thereof, and the handle includes a recess formed therein for engaging with the anchoring member and for anchoring and positioning the handle to the holder.

The second arm includes a slot formed in the free end portion of the second arm for receiving the dental floss filament. The holder includes a passage formed therein and communicating with the slot of the second arm for receiving the dental floss filament. The holder includes a cutter device attached thereto for selectively cutting the dental floss filament. The holder includes an extension extended therefrom and having a channel formed therein for receiving the cutter device.

A housing may further be provided and includes a chamber formed therein for receiving a reel of dental floss filament, the holder being attached to the housing.

The housing includes an opening formed therein, and a cover attached to the housing for enclosing the rear opening of the housing. The cover includes a compartment formed therein for receiving the reel of dental floss filament, and a pin extended into the compartment thereof for supporting the reel of dental floss filament.

The cover includes at least one catch provided thereon for engaging with the housing and for detachably attaching the cover to the housing. An outer receptacle may further be provided and includes a chamber formed therein for receiving the holder and the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a dental floss tooth pick in accordance with the present invention;

FIG. 2 is an enlarged partial exploded view of the dental floss tooth pick

FIG. 3 is a perspective view of the dental floss tooth pick;

FIG. 4 is a perspective view similar to FIG. 3, illustrating the operation for engaging a dental floss to a twisting or tightening means or device of the dental floss tooth pick;

FIG. 5 is an enlarged partial bottom perspective view illustrating the engagement of the dental floss to the twisting or tightening means or device of the dental floss tooth pick;

FIG. 6 is an enlarged partial upper perspective view illustrating the twisting or tightening operation of the dental floss to the dental floss tooth pick;

FIG. 7 is a perspective views similar to FIGS. 3 and 4, also illustrating the twisting or tightening operation for engaging or attaching the dental floss to the dental floss tooth pick; and

FIG. 8 is a further perspective view illustrating the operation of the dental floss tooth pick for cutting the dental floss from the tooth pick.

### DETAILED DESCRIPTION OF THE PREFERRED EMBODIMENT

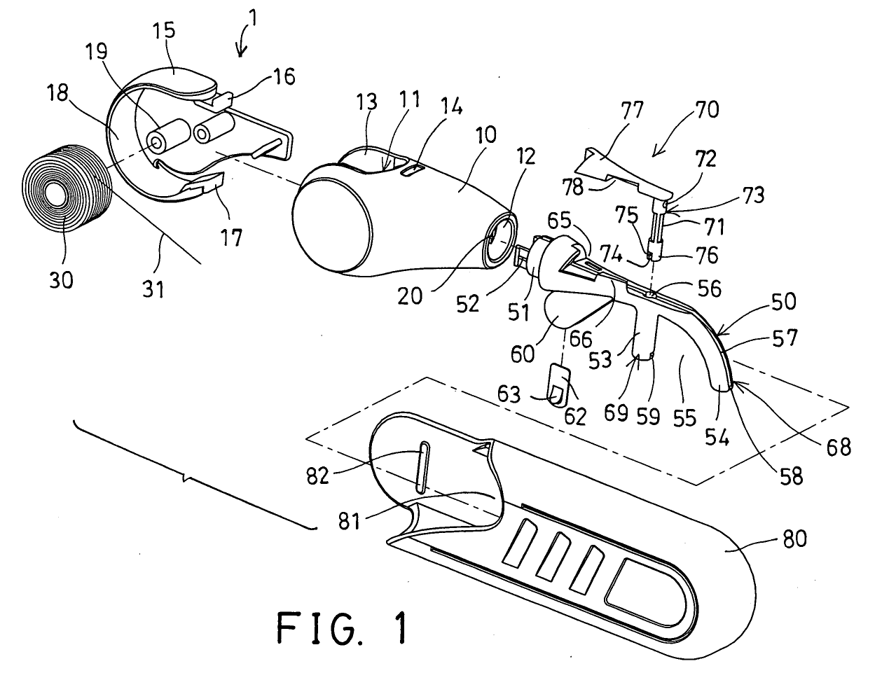

Referring to the drawings, and initially to FIG. 1, a dental floss tooth pick 1 in accordance with the present invention comprises a tooth pick body or housing 10 including a chamber 11 formed therein and having a front opening 12 and a rear opening 13 formed or provided therein, and including one or more, such as two cavities 14 formed therein and preferably located beside the rear opening 13 thereof, and a cover 15 attached to the housing 10 for enclosing the rear opening 13 of the housing 10.

As shown in FIGS. 1, 3-4, 7-8, for example, the cover 15 is provided for being attached to or engaged with the housing 10 and for sealing or enclosing the rear opening 13 of the housing 10, and includes one or more, such as two catches 16, 17 attached thereto or provided thereon or extended therefrom for engaging with the cavities 14 of the housing 10 and for detachably attaching or securing the cover 15 to the housing 10, and includes a compartment 18 formed therein (FIG. 1), and an axle or hub or pin 19 extended into the compartment 18 thereof. The housing 10 may further include one or more lock depressions 20 formed therein and communicating with the chamber 11 of the housing 10 (FIG. 1).

A coil or reel 30 of a dental floss filament 31 is engaged into the compartment 18 of the cover 15 and disposed or attached onto the pin 19, for allowing a new reel 30 of the dental floss filament 31 to be refilled into the compartment 18 of the cover 15. The dental floss filament 31 is engageable through the chamber 11 of the housing 10 and extendible out through the front opening 12 of the housing 10, and is normally made of wax-coated synthetic unplasticized vinyl resin material.

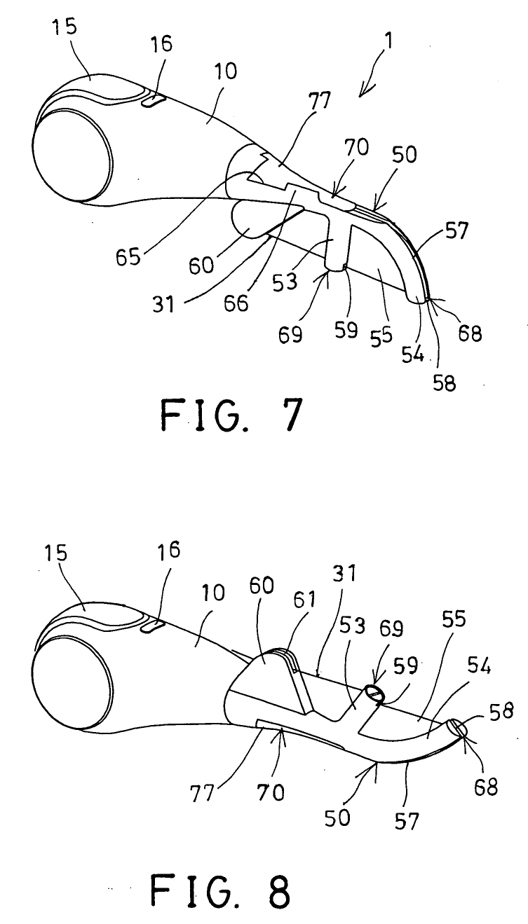

A holder 50 is further provided for detachably attaching to the housing 10, and includes an outer diameter reduced neck portion 51 for engaging into the front opening 12 of the housing 10, and includes one or more, such as two latches 52 attached thereto or provided thereon or extended therefrom for engaging with the lock depressions 20 of the housing 10 and for detachably attaching or securing the holder 50 to the housing 10. The latches 52 and the lock depressions 20 of the housing 10 are preferably arranged for allowing the holder 50 to be rotated or adjusted and attached or secured to the housing 10 at different angular positions (FIGS. 7, 8).

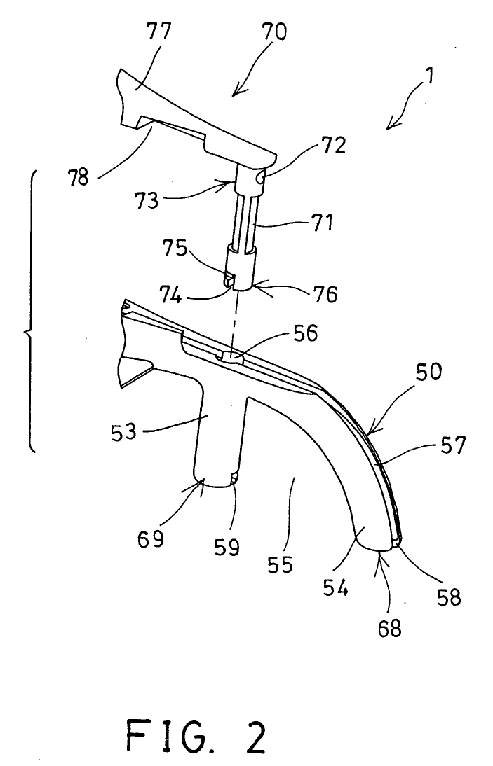

The holder 50 includes two arms 53, 54 formed thereon or extended therefrom for forming a substantially V or U-shaped structure and for forming a space 55 between the arms 53, 54 and for straddling or for receiving the dental floss filament 31, or for allowing the dental floss filament 31 to be engaged or extended through the space 55 of the holder 50. It is preferable that the first arm 53 includes a longitudinal or straight structure having a bore 56 formed therein (FIGS. 1, 2), and the other or second arm 54 includes a curved structure. The holder 50 further includes a passage 57 formed therein, such as formed in the upper portion thereof and communicating with the bore 56 of the first arm 53 (FIGS. 1, 2), and also formed in the upper portion of the arm 54 for receiving or engaging with the dental floss filament 31.

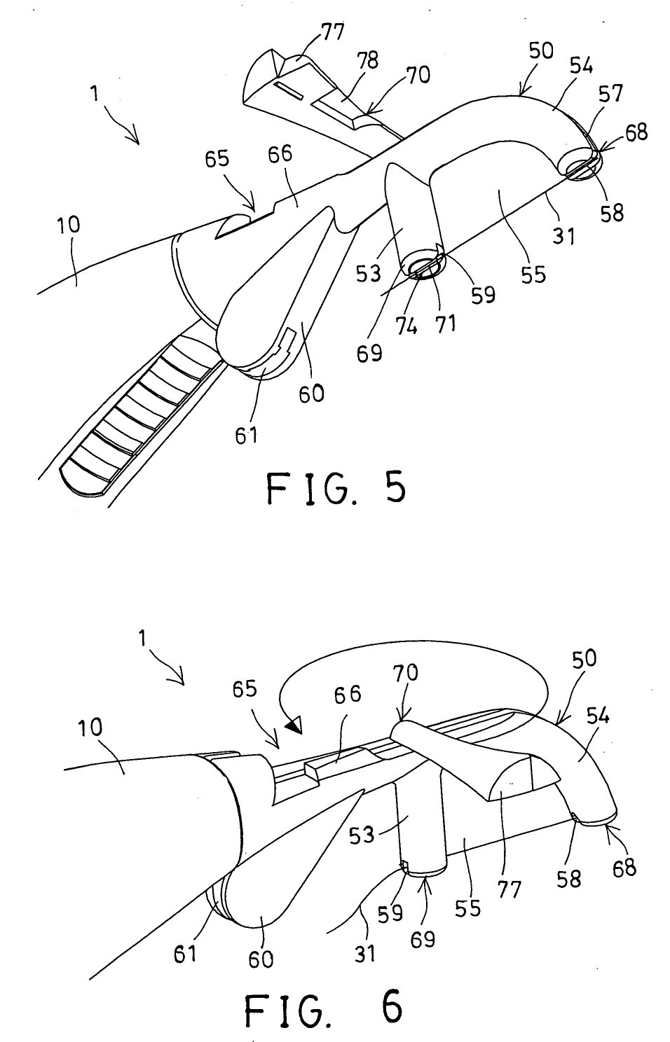

It is preferable that the arm 54 further includes a slot 58 formed in the bottom portion or free end portion 68 thereof (FIGS. 2, 5, 6, 8) and communicating with the passage 57 of the holder 50, also for receiving or engaging with the dental floss filament 31. The first arm 53 may also include a slot 59 formed in the bottom portion or free end portion 69 thereof and intersecting or communicating with the bore 56 of the first arm 53, also for receiving or engaging with the dental floss filament 31 (FIGS. 5, 6), and thus for allowing the dental floss filament 31 to be solidly attached to the arms 53, 54 of the holder 50. The dental floss filament 31 may thus be engaged through the space 55 of the holder 50 and attached or engaged with the bottom portions or free end portions 68, 69 of the arms 53, 54 of the holder 50.

The holder 50 may further include an extension 60 extended therefrom, and preferably located behind the arms 53, 54, or arranged to have the arm 53 to be located between the extension 60 and the other arm 54. The extension 60 includes a channel 61 formed therein (FIGS. 5, 6, 8), such as formed in the bottom portion thereof, and a cutter device 62 (FIG. 1) engaged into and retained in the channel 61 of the extension 60, the cutter device 62 includes a cutter blade 63 received in the channel 61 of the extension 60 for engaging with and for selectively cutting the dental floss filament 31 (FIG. 8).

A twisting or tightening means or device 70 is provided for twisting or tightening the dental floss filament 31 to the arms 53, 54 of the holder 50, and includes a mandrel 71 rotatably engaged into the bore 56 of the first arm 53, and includes an orifice 72 formed in the upper portion 73 of the mandrel 71 for receiving or for engaging with the dental floss filament 31, and includes an aperture 74 and a lock notch 75 formed in the lower portion 76 of the mandrel 71 and communicating with each other for receiving or engaging with the dental floss filament 31. The aperture 74 and the lock notch 75 formed in the lower portion 76 of the mandrel 71 may be formed into the typical L-shaped structure or the like for solidly receiving or engaging or retaining the dental floss filament 31 in the lock notch 75 after the dental floss filament 31 has been engaged through the aperture 74 of the mandrel 71.

The twisting or tightening means or device 70 includes a handle 77 provided on the upper portion thereof and preferably, but not necessarily perpendicular to the mandrel 71, for rotating the mandrel 71 relative to the arm 53 of the holder 50 and thus for twisting or tightening the dental floss filament 31 to the arms 53, 54 of the holder 50. The holder 50 may further include a notch 65 formed in the upper portion thereof and communicating with the passage 57 thereof and the bore 56 of the first arm 53 for selectively receiving the handle 77 of the twisting or tightening device 70, and an anchoring member 66 extended into the notch 65 thereof for anchoring the handle 77.

For example, the handle 77 includes a recess 78 formed therein (FIGS. 1, 2, 5) for engaging with the anchoring member 66 and thus for anchoring or positioning the handle 77 to the holder 50, and for preventing the handle 77 from being rotated relative to the holder 50 inadvertently. The dental floss tooth pick 1 may further include an outer receptacle 80 having a chamber 81 formed therein for receiving the holder 50 and the housing 10, and may further include one or more catches or anchoring members 82 for detachably attaching or anchoring the outer receptacle 80 to the holder 50 and the housing 10, and for allowing the holder 50 and the housing 10 to be safely received within the outer receptacle 80.

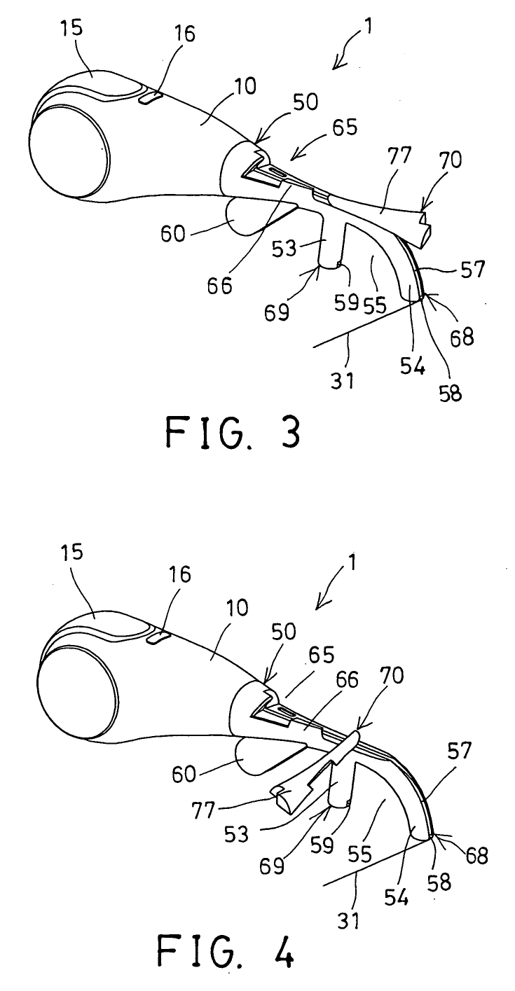

In operation, as shown in FIG. 3, the handle 77 may first be rotated relative to the holder 50 for about 180 degrees from the storing or receiving position as shown in FIG. 7 to the intermediate position as shown in FIG. 3, to have the orifice 72 of the mandrel 71 in line with the passage 57 of the holder 50, and for allowing the dental floss filament 31 to be received or engaged through the orifice 72 of the mandrel 71. The dental floss filament 31 may also be received or engaged through the orifice 72 of the mandrel 71 before the mandrel 71 is rotatably engaged into the bore 56 of the first arm 53.

The handle 77 may then be further rotated relative to the holder 50 for about 90 degrees from the intermediate position as shown in FIG. 3 to the outwardly or laterally working position as shown in FIGS. 4-6, to have the aperture 74 of the mandrel 71 in line with the slot 59 of the arm 53 of the holder 50, and thus for allowing the dental floss filament 31 to be engaged into the aperture 74 (FIGS. 5, 6) and the lock notch 75 of the mandrel 71. The handle 77 may then be rotated relative to the holder 50 for about 270 degrees (FIG. 6) from the outwardly or laterally working position as shown in FIGS. 4-6 to the storing or receiving position as shown in FIG. 7, such that the dental floss filament 31 may be solidly twisted or tightened or attached or secured onto the arms 53, 54 of the holder 50.

It is to be noted that the portion of the dental floss filament 31 which is engaged through the orifice 72 or engaged with the upper portion 73 of the mandrel 71 and the other portion of the dental floss filament 31 which is engaged through the aperture 74 and/or the lock notch 75 or engaged with the lower portion 76 of the mandrel 71 may both be rotated or twisted or tightened onto the arms 53, 54 of the holder 50 by rotating the mandrel 71 of the twisting or tightening means or device 70 relative to the arm 53 of the holder 50, for allowing the dental floss filament 31 to be solidly attached to the arms 53, 54 of the holder 50.

However, it is further to be noted that the mandrel 71 of the twisting or tightening means or device 70 may also be used to rotate or twist or tighten the dental floss filament 31 onto the holder 50 with only the upper portion 73 of the mandrel 71, or with only the lower portion 76 of the mandrel 71, when the dental floss filament 31 is directly attached or secured to the lower portion of the arm 53 without engaging through the aperture 74 of the mandrel 71 or to the lower portion of the arm 53 without engaging through the orifice 72 of the mandrel 71, such that the dental floss filament 31 may also be rotated or twisted or tightened onto the arms 53, 54 of the holder 50 by rotating the mandrel 71 of the twisting or tightening means or device 70 relative to the arm 53 of the holder 50. It is further to be noted that the mandrel 71 is not necessarily be engaged through the bore 56 of the first arm 53, but may be rotatably attached to the holder 50 and extended out or behind the first arm 53 for rotating or twisting or tightening or attaching the dental floss filament 31 to the holder 50.

The typical dental floss tooth picks failed to provide any twisting or tightening means or device for twisting or tightening the dental floss filament onto the separated arms of the U-shaped handles. After using, the mandrel 71 of the twisting or tightening means or device 70 may be rotated relative to the arm 53 of the holder 50 from the storing or receiving position as shown in FIG. 7 to the outwardly or laterally working position as shown in FIGS. 4-6, to allow the used portion or segment of the dental floss filament 31 to be pulled and disengaged from the holder 50, and the dental floss filament 31 may then be engaged into the channel 61 of the extension 60, to have the used portion or segment of the dental floss filament 31 to be cut by the cutter device 62.

Accordingly, the dental floss tooth pick in accordance with the present invention includes a dental floss attachable onto a U-shaped holder and tightenable onto the U-shaped holder by the users themselves.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A dental floss tooth pick comprising:
a holder including a first arm and a second arm extended therefrom for forming a space between said first and said second arms, said first and said second arms each including a free end portion,
a dental floss filament attached onto said holder and engaged with said free end portions of said first and said second arms and extended through said space of said holder, and
means for tightening said dental floss filament to said holder.

2. The dental floss tooth pick as claimed in claim 1, wherein said tightening means includes a rotatable mandrel for engaging with said dental floss filament and for rotating said dental floss filament relative to said holder to rotate and tighten said dental floss filament to said holder.

3. The dental floss tooth pick as claimed in claim 2, wherein said mandrel includes an orifice formed in an upper portion thereof for receiving said dental floss filament and for rotating said dental floss filament relative to said holder.

4. The dental floss tooth pick as claimed in claim 3, wherein said mandrel includes an aperture formed in a lower portion thereof for receiving said dental floss filament and for rotating said dental floss filament relative to said holder.

5. The dental floss tooth pick as claimed in claim 4, wherein said first arm includes a bore formed therein for rotatably receiving said mandrel and includes a slot formed in said free end portion of said first arm for aligning with said aperture of said mandrel and for receiving said dental floss filament.

6. The dental floss tooth pick as claimed in claim 4, wherein said mandrel includes a lock notch formed therein and communicating with said aperture of said mandrel for receiving and engaging with said dental floss filament.

7. The dental floss tooth pick as claimed in claim 2, wherein said mandrel includes a handle provided thereon for rotating said mandrel relative to said holder.

8. The dental floss tooth pick as claimed in claim 7, wherein said holder includes a notch formed therein for selectively receiving said handle.

9. The dental floss tooth pick as claimed in claim 8, wherein said holder includes an anchoring member extended into said notch thereof, and said handle includes a recess formed therein for engaging with said anchoring member and for anchoring and positioning said handle to said holder.

10. The dental floss tooth pick as claimed in claim 1, wherein said second arm includes a slot formed in said free end portion of said second arm for receiving said dental floss filament.

11. The dental floss tooth pick as claimed in claim 10, wherein said holder includes a passage formed therein and communicating with said slot of said second arm for receiving said dental floss filament.

12. The dental floss tooth pick as claimed in claim 10, wherein said holder includes a cutter device attached thereto for selectively cutting said dental floss filament.

13. The dental floss tooth pick as claimed in claim 12, wherein said holder includes an extension extended therefrom and having a channel formed therein for receiving said cutter device.

14. The dental floss tooth pick as claimed in claim 1 further comprising a housing including a chamber formed therein for receiving a reel of dental floss filament, said holder being attached to said housing.

15. The dental floss tooth pick as claimed in claim 14, wherein said housing includes an opening formed therein, and a cover attached to said housing for enclosing said rear opening of said housing.

16. The dental floss tooth pick as claimed in claim 15, wherein said cover includes a compartment formed therein for receiving said reel of dental floss filament, and a pin extended into said compartment thereof for supporting said reel of dental floss filament.

17. The dental floss tooth pick as claimed in claim 15, wherein said cover includes at least one catch provided thereon for engaging with said housing and for detachably attaching said cover to said housing.

18. The dental floss tooth pick as claimed in claim 1 further comprising an outer receptacle having a chamber formed therein for receiving said holder and said housing.
